(19) United States
(12) Patent Application Publication
(10) Pub. No.: US 2010/0197364 A1
(43) Pub. Date: Aug. 5, 2010

(54) Apparatus controllable by mobile phone for power management

(76) Inventor: Jenching Lee, Taipei (TW)

Correspondence Address: SAM CHEN, 7F-1, 293, ROOSEVELT ROAD, SEC 3, TAIPEI, TW

(21) Appl. No.: 12/365,906

(22) Filed: Feb. 5, 2009

(51) Int. Cl. H04M 1/00

(52) U.S. Cl. 455/572

(57) ABSTRACT

An apparatus controllable by a mobile phone for power management is provided. A processor controller is adapted to instruct a GSM/CDMA wireless module to send a short text message in the form of SMS to a mobile phone user who is at a remote location and is in charge of the management of a predetermined facility equipped with the via an antenna and a mobile network if power outage occurs. The mobile phone user is capable of sending a short text message in the form of SMS to the processor controller via the antenna and the GSM/CDMA wireless module to shut down the processor controller.

### BACKGROUND OF THE INVENTION

1. Field of Invention

The invention relates to apparatuses being adapted to control by a mobile phone and more particularly to a power management apparatus which can be controlled by a mobile phone to, for example, shut down one of electrical devices if the device powered by the apparatus does not function normally (e.g., due to power outage).

2. Description of Related Art

One prior art discloses an apparatus which can be controlled by another apparatus by transmitting signals thereto over PHS and method therefor. Another prior art discloses a power management apparatus which can be controlled by another apparatus by transmitting signals thereto from RS485 interface in case of power outage.

Both prior art documents are directed to a technique of controlling a domestic electrical appliance or a specific device by an apparatus from a long distance.

Still another prior art is disclosed for controlling on/off of an electrical appliance by a timer electrically connected thereto. Yet another prior art discloses an anti-burglar apparatus connected to a specific device. The anti-burglar apparatus is activated to transmit signals (e.g., in the form of short message service (SMS)) to a GSM mobile phone as alarm if an abnormality occurs. Such technique is also employed to monitor the location of an old man recently.

An object to be controlled or monitored is required to transmit signals to a master apparatus if case of abnormality as disclosed by the above prior art techniques. Further, a user may have to control the object by transmitting a signal to the object in response. Alternatively, the response is done over the Internet. This means that the computer is required to be on all the time. This is not an energy saving technique and is furthermore impractical. Also, some devices are not designed to be controlled by computer. Moreover, real time control may be not possible by means of computer. It is noted that not all people can use computer.

For timer control, it also has disadvantages. For example, a rice cooker is programmed by a computer to cook after 30 minutes. Further, 30-minute warming is done. Thereafter, a good meal is done. However, the rice cooker and the computer are required to be electrically connected together. Additional power cord may cause hazard if sufficient care is not done. Thus, the need for improvement still exists.

### SUMMARY OF THE INVENTION

It is therefore one object of the invention to provide an apparatus controllable by a mobile phone for power management.

The above and other objects, features and advantages of the invention will become apparent from the following detailed description taken with the accompanying drawings.

### BRIEF DESCRIPTION OF THE DRAWINGS

FIG. 1 is a perspective view of the back panel of a power management apparatus according to the invention;

FIG. 2 is a perspective view of the front panel of the power management apparatus; and

FIG. 3 is a schematic block diagram of the power management apparatus.

### DETAILED DESCRIPTION OF THE INVENTION

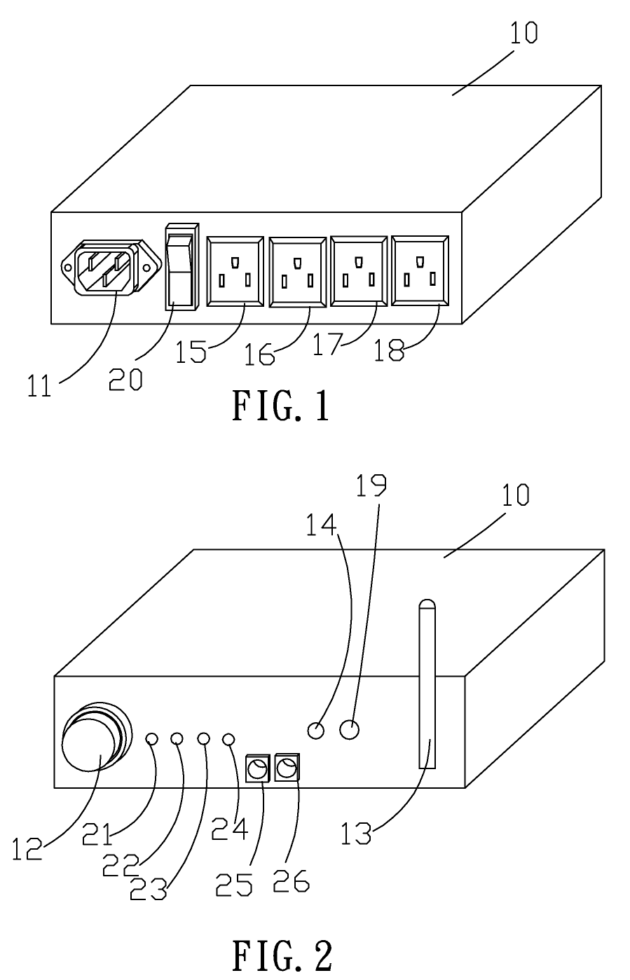

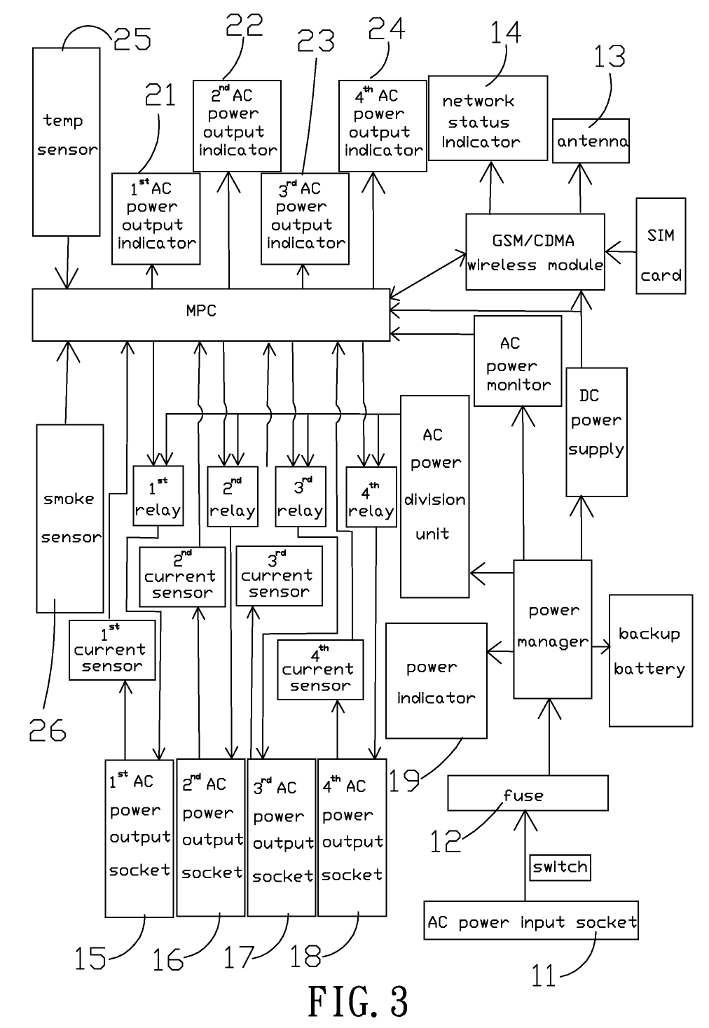

Referring to FIGS. 1 to 3, a power management apparatus in accordance with the invention comprises the following components as discussed in detail below.

A parallelepiped housing 10 has a back panel with the following components provided. A power socket 11 is connected to a power cord (not shown) for obtaining AC power therefrom. A power switch 20 is provided besides the power socket 11. Four AC output sockets 15, 16, 17 and 18 are provided besides the power switch 20 distal the power socket 11.

A front panel of the housing 10 has the following components. A fuse 12 is electrically connected to the power socket 11. A power indicator 19 for indicating power input status is provided. An antenna 13 is provided for signal transmission and reception. A network status (i.e., network connection status) indicator 14 is provided besides the power indicator 1 9. Four relay status indicators 21, 22, 23 and 24 each for indicating the status of the corresponding one of AC outputs (i.e., AC output indicators) are provided. Finally, two sensors (e.g., temperature and smoke sensors) 25, 26 are provided for sensing abnormal temperature and smoke respectively. Note that all of the indicators are LEDs (light emitting-diodes).

The housing is provided with the following internal components which are all not numbered. A power manager is electrically connected to the fuse 12. The power manager serves as an adapter to convert AC power into DC. A master control unit comprises a controller (e.g., Micro Processor Controller (MPC)) and a memory (e.g., electrically erasable programmable read-only memory (EEPROM)) adapted to store data from the MPC and send data to the MPC upon request from the MPC. The MPC is powered by the power manager. The relay status indicators 21, 22, 23 and 24 are controlled by the MPC. A GSM/CDMA (Global System for Mobile Communications/code division multiple access) wireless module is provided and is also powered by the power manager. The GSM/CDMA wireless module is used to register with the Internet and send or receive short text messages in the form of SMS via the antenna 13, and communicate with the MPC by AT commands. Also, the network status indicator 14 is controlled by the GSM/CDMA wireless module. A SIM (Subscriber Identify Module) card is used to store information including a registered mobile telephone numbered for the GSM/CDMA wireless module. An AC power division unit is interconnected the fuse 12 and four relays. Each relay is further connected to one of four current sensors (CSs). Thus, AC power input (e.g., 110 VAC or 220 VAC) from the AC power division unit may feed to the AC output sockets 15, 16, 17 and 18 via the corresponding pairs of relay and CS respectively. Thus, any electrical device may be connected to one of the AC output sockets 15, 16, 17 and 18 for sourcing electric power therefrom for consumption. Each CS may report status including overloading of the load (i.e., the connected electrical device) to the MPC via analog signals. Also, any CS may stop supplying power to its connected device as commanded by the MPC if overloading occurs. An AC power monitor is powered by the power manager and is adapted to communicate with the MPC via digital signals. Hence, the MPC is aware of power outage as power outage can be sensed by the AC power monitor via the power manager and the fuse 12 and the AC power monitor may send a power outage signal to the MPC. The sensors 25, 26 are adapted to inform any abnormality to the MPC by sending analog signals thereto. Finally, a backup power supply (e.g., rechargeable battery) is electrically connected to the power manager. The backup power supply is powered by the power manager in normal condition and is adapted to supply power to the apparatus in case of power outage. Note that the MPC also has the function of timer.

The following is a description of six applications of the invention.

The power management apparatus is installed in a control room and is adapted to monitor whether power outage occurs or not. The apparatus may automatically send a short text message in the form of SMS to a mobile phone user who is in charge of the management of the control room via mobile network if power outage occurs (i.e., the mobile phone user is not at site). Next, the mobile phone user may send a short text message in the form of SMS to the apparatus to shut down the apparatus as a response. Hence, the control room is deactivated. Moreover, the temperature and smoke sensors 25, 26 are adapted to sense abnormal temperature and smoke in the control room respectively. Thus, any abnormality detected by either sensor 25 or 26 may be sent to the MPC via signals. In response, the apparatus shuts down and automatically sends a short text message in the form of SMS to the mobile phone user. The mobile phone user may immediately perform an appropriate action as response.

The power management apparatus is installed in a greenhouse and is adapted to monitor whether power outage occurs or not. Also, the apparatus is adapted to set on and off times of power outputs and control the on and off of lights, fans, etc. That is, functions as a timer. The apparatus may automatically send a short text message in the form of SMS to a mobile phone user who is in charge of the management of the greenhouse via mobile network if any abnormality including power outage occurs (i.e., the mobile phone user is not at site). Next, the mobile phone user may send a short text message in the form of SMS to the apparatus to shut down the apparatus as a response. Hence, the greenhouse is deactivated. Moreover, the temperature and smoke sensors 25, 26 are adapted to sense abnormal temperature and smoke in the control room respectively. Thus, any abnormality detected by either sensor 25 or 26 may be sent to the MPC via signals. In response, the apparatus shuts down and automatically sends a short text message in the form of SMS to the mobile phone user. The mobile phone user may immediately perform an appropriate action as response.

The power management apparatus is installed associated with a billboard and is adapted to monitor whether power outage occurs or not. Also, the apparatus is adapted to set on and off times of power outputs, control the on and off of advertisement lights (i.e., functioning as a timer), and monitor whether the lights are functioning normally or not. The apparatus may automatically send a short text message in the form of SMS to a mobile phone user who is in charge of the management of the billboard via mobile network if power outage occurs (i.e., the mobile phone user is not at site). Next, the mobile phone user may send a short text message in the form of SMS to the apparatus to shut down the apparatus as a response. That is, the billboard is deactivated.

The power management apparatus is installed in a house and is electrically connected to at least one electrical appliance. The apparatus is adapted to monitor whether power outage occurs or not. Also, the apparatus is adapted to set on and off times of power outputs, control the on and off of the appliance(s) (i.e., functioning as a timer), and monitor whether the appliance(s) is(are) functioning normally or not. The apparatus may automatically send a short text message in the form of SMS to a mobile phone user who is in charge of the management of the house via mobile network if power outage occurs (i.e., the mobile phone user is not in the house). Next, the mobile phone user may send a short text message in the form of SMS to the apparatus to shut down the apparatus or only the malfunctioned appliance as a response. Moreover, the temperature and smoke sensors 25, 26 are adapted to sense abnormal temperature and smoke in the house respectively. Thus, any abnormality detected by either sensor 25 or 26 may be sent to the MPC via signals. In response, the apparatus shuts down and automatically sends a short text message in the form of SMS to the mobile phone user. The mobile phone user may immediately perform an appropriate action as response.

The power management apparatus is installed in a refrigeration compartment and is adapted to monitor whether power outage occurs or not. The apparatus may automatically send a short text message in the form of SMS to a mobile phone user who is in charge of the management of the refrigeration compartment via mobile network if power outage occurs (i.e., the mobile phone user is not at site). Next, the mobile phone user may send a short text message in the form of SMS to the apparatus to shut down the apparatus as response. Moreover, the temperature sensor 25 is adapted to sense abnormal temperature in the refrigeration compartment. Thus, any abnormality detected by the sensor 25 may be sent to the MPC via signals. In response, the apparatus shuts down and automatically sends a short text message in the form of SMS to the mobile phone user. The mobile phone user may immediately perform an appropriate action as response.

The power management apparatus is installed in a cooling tower and is adapted to monitor whether power outage occurs or not. The apparatus may automatically send a short text message in the form of SMS to a mobile phone user who is in charge of the management of the cooling tower via mobile network if power outage occurs (i.e., the mobile phone user is not at site). Next, the mobile phone user may send a short text message in the form of SMS to the apparatus to shut down the apparatus as a response. Moreover, the temperature and smoke sensors 25, 26 are replaced by a water level detector which is adapted to control the on and off times of a sump pump (i.e., timer control). That is, the apparatus may activate the sump pump to feed water to the cooling tower if the water level is too low and deactivate the same if the water level has reached a predetermined high level.

While the invention herein disclosed has been described by means of specific embodiments, numerous modifications and variations could be made thereto by those skilled in the art without departing from the scope and spirit of the invention set forth in the claims.

What is claimed is:

1. A power management apparatus comprising:
a housing;
a power socket adapted to connect to a power cord for obtaining AC (alternating current) power therefrom;
a power switch for turning on or off the AC power;
a plurality of AC output sockets each adapted to connect to a device;
a fuse connected to the power socket;
a processor controller adapted to perform a plurality of predetermined functions;
a memory adapted to store data from the processor controller and send data to the processor controller upon request therefrom;
a power indicator being controlled by the processor controller for indicating power input status;
an antenna;
a power manager connected to the fuse and adapted to convert AC into DC (direct current) for powering the processor controller;
a plurality of relay status indicators controlled by the processor controller;
a GSM/CDMA (Global System for Mobile Communications/code division multiple access) wireless module powered by the power manager, the GSM/CDMA wireless module being adapted to register with the Internet, send or receive short text messages in the form of SMS (short message service) via the antenna, and communicate with the processor controller by commands;
a network status indicator controlled by the GSM/CDMA wireless module for indicating network connection status;
a SIM (Subscriber Identify Module) card for storing information including a registered mobile telephone numbered for the GSM/CDMA wireless module;
an AC power division unit connected to the power manager;
a plurality of sets of relay and CS (current sensor), the relay of each set being interconnected with the CS of the same set and the AC power division unit and being in signal communication with the processor controller, and the CS of each set being connected to one of the AC output sockets;
an AC power monitor powered by the power manager and adapted to be in signal communication with the processor controller for reporting a power outage signal thereto if that occurs;
a plurality of sensor units each adapted to sense a predetermined external condition and inform any abnormality to the processor controller by sending analog signals thereto; and
a backup power supply powered by the power manager,
wherein the processor controller is adapted to instruct the GSM/CDMA wireless module to send a short text message in the form of SMS to a mobile phone user who is at a remote location and is in charge of the management of a predetermined facility equipped with the power management apparatus via the antenna and a mobile network if power outage occurs; and the mobile phone user is capable of sending a short text message in the form of SMS to the processor controller via the antenna and the GSM/CDMA wireless module to shut down the processor controller.

2. The power management apparatus of claim 1, wherein one of the predetermined functions is timer control.

3. The power management apparatus of claim 1, wherein the sensor units are comprised of a smoke sensor and a temperature sensor.

4. The power management apparatus of claim 1, wherein the processor controller is a MPC (micro processor controller).

5. The power management apparatus of claim 1, wherein each of the indicators is an LED (light emitting diode).
